(19) United States
(12) Patent Application Publication
(10) Pub. No.: US 2020/0272205 A1
(43) Pub. Date: Aug. 27, 2020

(54) DISPLAY SCREEN ASSEMBLY AND MOBILE TERMINAL

(71) Applicant: VIVO MOBILE COMMUNICATION CO., LTD., Chang'an Dongguan, Guangdong (CN)

(72) Inventor: Hongyang WEI, Chang'an Dongguan (CN)

(73) Assignee: VIVO MOBILE COMMUNICATION CO., LTD., Chang'an Dongguan, Guangdong (CN)

(21) Appl. No.: 16/646,532

(22) PCT Filed: Aug. 28, 2018
(86) PCT No.: PCT/CN2018/102697

§ 371 Date: Mar. 11, 2020

(30) Foreign Application Priority Data
Sep. 14, 2017 (CN) 201710826480.0

(51) Int. Cl. G06F 1/16; H04M 1/02; G06F 21/32

(52) U.S. Cl. CPC G06F 1/1656; H04M 1/0266; G06F 1/1684; G06F 21/32; H04M 1/0277

(57) ABSTRACT

A display screen assembly and a mobile terminal are provided. The display screen assembly includes a display screen, a shock-proof layer and a flexible printed circuit board which are sequentially laminated. The flexible printed circuit board includes a circuit board body and a bent portion extending from the circuit board body toward the display screen; the bent portion is electrically connected to the display screen; a fingerprint chip is arranged on a first surface of the circuit board body; and the circuit board body is electrically connected to the fingerprint chip; the first surface is an end surface of the circuit board body that is facing the display screen; a through hole for accommodating the fingerprint chip is arranged in the shock-proof layer at a position corresponding to the fingerprint chip.

### CROSS-REFERENCE TO RELATED APPLICATION

This application claims a priority to Chinese Patent Application No. 201710826480.0 filed in China on Sep. 14, 2017, the disclosure of which is incorporated in its entirety by reference herein.

### TECHNICAL FIELD

The present disclosure relates to the field of communication technologies, in particular to a display screen assembly and a mobile terminal.

### BACKGROUND

With the continuous development of technologies, a display screen of a mobile terminal, such as smart phone, is getting larger and larger, and a full-screen mobile terminal has become a development trend. As to the full-screen mobile terminal, conventional structure for fingerprint identification is no longer applicable, and a display screen with a fingerprint identification function has become a new technological direction.

In the related art, the display screen with the fingerprint identification function is generally manufactured by stacking a fingerprint module on a back side of the display screen. For example, the fingerprint module is adhered to the back side of the display screen by using a foam adhesive, a shadowless glue or the like, then a circuit board of the fingerprint module is connected to the circuit board of the display screen and finally connected to a motherboard of the mobile terminal for communication. However, since the fingerprint module itself occupies a large space, if the fingerprint module is designed to be stacked on the back side of the display screen, an overall design space of the mobile terminal is encroached on. It can be seen that the stacked structure of the display screen and the fingerprint module in the related art has a problem of occupying excessive space.

### SUMMARY

A display screen assembly is provided by some embodiments of the present disclosure. The display screen assembly includes a display screen, a shock-proof layer and a flexible printed circuit board which are sequentially laminated. The flexible printed circuit board includes a circuit board body and a bent portion extending from the circuit board body toward the display screen; the bent portion is electrically connected to the display screen; a fingerprint chip is arranged on a first surface of the circuit board body; and the circuit board body is electrically connected to the fingerprint chip; the first surface is an end surface of the circuit board body that is facing the display screen; a through hole for accommodating the fingerprint chip is arranged in the shock-proof layer at a position corresponding to the fingerprint chip.

A mobile terminal is provided by some embodiments of the present disclosure. The mobile terminal includes a display screen cover plate and the display screen assembly as described above. The display screen cover plate is snugly attached to the display screen of the display screen assembly.

### BRIEF DESCRIPTION OF THE DRAWINGS

FIG. 1 is a schematic structural view of a display screen assembly snugly fitted with a display screen cover plate according to some embodiments of the present disclosure;

FIG. 2 is a sectional view taken along line A-A in FIG. 1;

FIG. 3 is an exploded view of a display screen assembly snugly fitted with a display screen cover plate according to some embodiments of the present disclosure.

### DETAILED DESCRIPTION

The technical solutions of the embodiments of the present disclosure will be clearly and completely described below in conjunction with the drawings of the embodiments of the present disclosure. It is apparent that the described embodiments are a part of the embodiments of the present disclosure, and not all of them. All other embodiments obtained by a person ordinary skilled in the art based on the embodiments of the present disclosure without any creative efforts fall within the scope of the present disclosure.

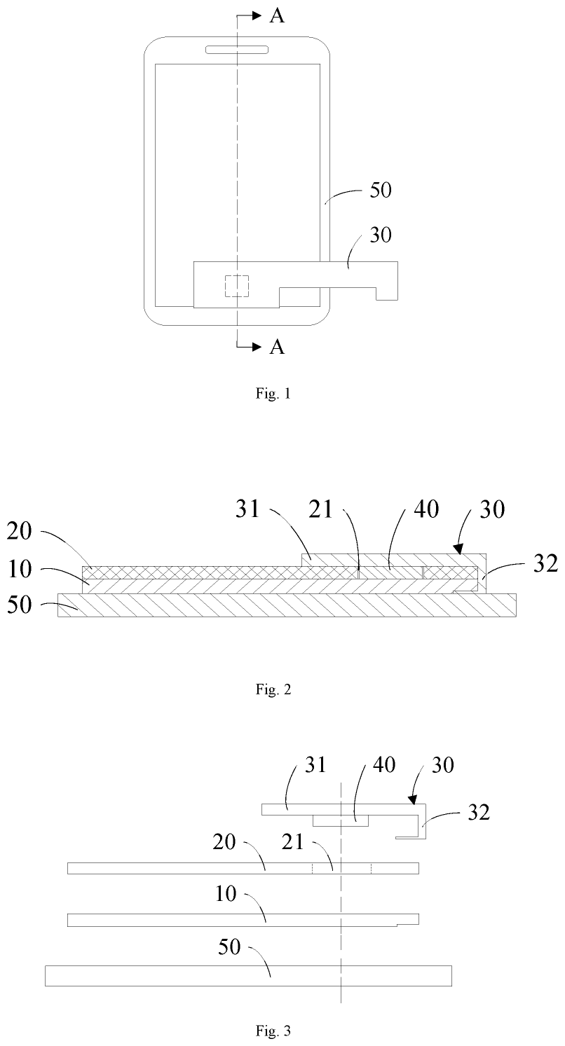

As shown in FIGS. 1-3, FIG. 1 is a schematic structural view of a display screen assembly snugly fitted with a display screen cover plate according to some embodiments of the present disclosure; FIG. 2 is a sectional view taken along line A-A in FIG. 1; FIG. 3 is an exploded view of a display screen assembly snugly fitted with a display screen cover plate according to some embodiments of the present disclosure.

As shown in FIG. 1 and FIG. 2, the display screen assembly provided by some embodiments of the present disclosure includes a display screen 10, a shock-proof layer 20 and a flexible printed circuit board 30 which are sequentially laminated. The flexible printed circuit board 30 includes a circuit board body 31 and a bent portion 32 extending from the circuit board body 31 toward the display screen 10; the bent portion 32 is electrically connected to the display screen 10; a fingerprint chip 40 is arranged on a first surface of the circuit board body 31; and the circuit board body 31 is electrically connected to the fingerprint chip 40; the first surface is an end surface of the circuit board body 31 that is facing the display screen 10; a through hole 21 for accommodating the fingerprint chip 40 is arranged in the shock-proof layer 20 at a position corresponding to the fingerprint chip 40.

The display screen assembly further includes a peripheral electronic component configured to enable a fingerprint identification function of the fingerprint chip 40, and the peripheral electronic component is arranged on the circuit board body 31. In this embodiment, the peripheral electronic component may be arranged on a first surface of the circuit board body 31 together with the fingerprint chip 40, or may be arranged on a second surface of the circuit board body 31. The second surface is an end surface of the circuit board body 31 that is away from the display screen 10. Moreover, the peripheral electronic component for controlling and enabling the function of the display screen 10 is generally also arranged on the second surface of the circuit board body 31.

It should be noted that a position of the fingerprint chip 40 on the flexible printed circuit board 30 needs to be designed according to a requirement of an entire mechanical structure of the mobile terminal. For example, if the fingerprint identification function needs to be implemented in a center position of the display screen 10 of the mobile terminal, the fingerprint chip 40 needs to be designed to correspond to the center position of the display screen 10; if the fingerprint identification function needs to be implemented at a lower position of the display screen 10, the fingerprint chip 40 needs to be designed to correspond to the lower position of the display screen 10. As shown in FIG. 1 specifically, in this embodiment, a position of the fingerprint chip 40 in FIG. 1 is determined to be at the lower end of the display screen 10.

In some embodiments of the present disclosure, the fingerprint chip 40, the peripheral electronic component and the circuit structure configured for implementing the fingerprint identification function can be designed to be located on the flexible printed circuit board 30 of the display screen 10, and the fingerprint chip 40, the peripheral electronic component and the circuit structure can be manufactured simultaneously with the flexible printed circuit board 30 of the display screen 10 by means of a surface mount technology (SMT). The fingerprint chip 40, the peripheral electronic component and the circuit structure are all arranged on the circuit board body 31 of the flexible printed circuit board 30. In this way, by integrating the fingerprint chip 40 for implementing the fingerprint identification function on the flexible printed circuit board 30 of the display screen 10 by design, compared with designing the fingerprint module to be stacked on the display screen, the structural design can be greatly simplified, and the occupied space can be saved.

It should be noted additionally that, by placing the fingerprint chip 40 in the through hole 21 of the shock-proof layer 20, not only can the fingerprint chip 40 be effectively protected, but also the problems of the conventional display-screen fingerprint structure, such as complicated stacking, large space occupation and cumbersome interconnections between modules, can be mitigated. In addition, the fingerprint chip 40 may be fixedly connected to the circuit board body 31 by soldering. Compared with fixing the fingerprint module to the display screen by an adhering process in the display-screen fingerprint structure in the related art, a better connection strength is achieved and a risk of the entire mechanical structure in a mechanical test and an environment test can be effectively reduced.

Optionally, in order to improve an identification effect of the fingerprint chip 40, especially in the case that the fingerprint chip 40 is an optical chip, the shock-proof layer 20 may be made of an elastic light-shielding material. For example, the shock-proof layer 20 may be a foam layer having a light-shielding function. The foam has characteristics such as a good elasticity, light weight and reliable performance.

As shown in FIGS. 2 and 3, an assembling process of the display screen assembly is as follows: first, the shock-proof layer 20 and the circuit board body 31 can be snugly attached, specifically, which can be realized by sleeving the through hole 21 of the shock-proof layer 20 onto the fingerprint chip 40 arranged on the circuit board body 31; then, the display screen 10 is snugly fitted to a surface of the shock-proof layer 20 that is away from the circuit board body 31, and the bent portion 32 of the flexible printed circuit board 30 enables an electrical connection to the display screen 10.

The through hole 21 and the fingerprint chip 40 also have a positioning function, to facilitate a snug fixation of the shock-proof layer 20 and the circuit board body 31. In the case that the through hole 21 is designed to be a rectangular through hole, the positioning function of the through hole 21 and the fingerprint chip 40 is even better.

It needs to be further noted that, in order to further improve user experience, at least one fingerprint chip 40 may be arranged on the flexible printed circuit board 30. For example, the fingerprint chips 40 may be arranged at both upper and lower ends of a corresponding display screen 10, or the fingerprint chips 40 may be arranged at both left and right sides of a corresponding display screen 10, or the fingerprint chips 40 may be arranged at four corners of a corresponding display screen 10. In the case that at least two fingerprint chips 40 are provided, a user can select to enable the identification function of one or at least two fingerprint chips 40, or select none. The user can make a specific setting according to his own condition, so as to improve the user experience.

As shown in FIG. 1 and FIG. 2, some embodiments of the present disclosure are further related to a mobile terminal. The mobile terminal includes the display screen cover plate 50 and the display screen assembly as described above. The display screen cover plate 50 is snugly attached to the display screen 10 of the aforementioned display screen assembly.

Optionally, the mobile terminal further includes a motherboard and a board-to-board connector, the flexible printed circuit board 30 of the display screen assembly is electrically connected to the motherboard through the board-to-board connector. Compared with the display-screen fingerprint structure in the related art, in which the circuit board of the fingerprint module needs to be electrically connected to the flexible printed circuit board 30 of the display screen 10 first, and then be connected to the motherboard through a board-to-board connector to perform communication, the display screen assembly provided in some embodiments of the present disclosure realizes the connection and the communication between the flexible printed circuit board 30 and the motherboard by integrating the fingerprint chip 40 with the fingerprint identification function on the flexible printed circuit board 30 of the display screen 10 by design and utilizing the board-to-board connector, so that an installation space of the mobile terminal for installing the fingerprint module can be reduced, additionally, a production yield of the display screen assembly can be improved and a production cost can be reduced.

The mobile terminal may be a mobile phone, a tablet computer, an e-book reader, etc.

It should be noted that, the implementation manner of the embodiments of the display screen assembly is also applicable to the embodiments of the mobile terminal and can achieve the same technical effect, which will not be repeated here.

The above embodiments are merely optional embodiments of the present disclosure. It should be noted that improvements and modifications may be made by those skilled in the art without departing from the principle of the present disclosure, and these improvements and modifications shall also be deemed as falling within the scope of the present disclosure.

1. A display screen assembly, comprising: a display screen, a shock-proof layer and a flexible printed circuit board sequentially laminated,
wherein the flexible printed circuit board comprises a circuit board body and a bent portion extending from the circuit board body toward the display screen, the bent portion is electrically connected to the display screen; a fingerprint chip is arranged on a first surface of the circuit board body, and the circuit board body is electrically connected to the fingerprint chip; the first surface is an end surface of the circuit board body that is facing the display screen; a through hole for accommodating the fingerprint chip is arranged in the shock-proof layer at a position corresponding to the fingerprint chip.

2. The display screen assembly according to claim 1, wherein the shock-proof layer is made of an elastic light-shielding material.

3. The display screen assembly according to claim 1, wherein the shock-proof layer is a foam layer.

4. The display screen assembly according to claim 1, further comprising a peripheral electronic component configured to enable a fingerprint identification function of the fingerprint chip, wherein the peripheral electronic component and a circuit structure are arranged on the circuit board body.

5. The display screen assembly according to claim 4, wherein the peripheral electronic component and the circuit structure are located on a second surface of the circuit board body, the second surface is an end surface of the circuit board body that is away from the display screen.

6. The display screen assembly according to claim 1, wherein the fingerprint chip is electrically connected to the circuit board body by means of soldering.

7. The display screen assembly according to claim 1, wherein the through hole is a rectangular through hole.

8. A mobile terminal, comprising a display screen cover plate and the display screen assembly according to claim 1, wherein the display screen cover plate is snugly attached to the display screen of the display screen assembly.

9. The mobile terminal according to claim 8, wherein the mobile terminal further comprises a motherboard and a board-to-board connector, a circuit board of the display screen assembly is electrically connected to the motherboard through the board-to-board connector.

10. The mobile terminal according to claim 8, wherein the mobile terminal comprises a mobile phone, a tablet computer or an e-book reader.

11. The display screen assembly according to claim 2, wherein the fingerprint chip is electrically connected to the circuit board body by means of soldering.

12. The display screen assembly according to claim 3, wherein the fingerprint chip is electrically connected to the circuit board body by means of soldering.

13. The display screen assembly according to claim 4, wherein the fingerprint chip is electrically connected to the circuit board body by means of soldering.

14. The display screen assembly according to claim 5, wherein the fingerprint chip is electrically connected to the circuit board body by means of soldering.

15. The display screen assembly according to claim 2, wherein the through hole is a rectangular through hole.

16. The display screen assembly according to claim 3, wherein the through hole is a rectangular through hole.

17. The display screen assembly according to claim 4, wherein the through hole is a rectangular through hole.

18. The display screen assembly according to claim 5, wherein the through hole is a rectangular through hole.

19. A mobile terminal, comprising a display screen cover plate and the display screen assembly according to claim 2, wherein the display screen cover plate is snugly attached to the display screen of the display screen assembly.

20. A mobile terminal, comprising a display screen cover plate and the display screen assembly according to claim 3, wherein the display screen cover plate is snugly attached to the display screen of the display screen assembly.
